(19) United States
(12) Patent Application Publication
(10) Pub. No.: US 2026/0004386 A1
(43) Pub. Date: Jan. 1, 2026

(54) METHOD AND ELECTRONIC DEVICE FOR OPTIMIZING FRAME BUFFER MANAGEMENT

(71) Applicant: SAMSUNG ELECTRONICS CO., LTD., Suwon-si (KR)

(72) Inventors: Sethu Mathavan Baskaran, Karnataka (IN); Sripurna Mutalik, Karnataka (IN); Anuradha Kanukotla, Karnataka (IN)

(73) Assignee: SAMSUNG ELECTRONICS CO., LTD., Suwon-si (KR)

(21) Appl. No.: 19/314,884

(22) Filed: Aug. 29, 2025

Related U.S. Application Data
(63) Continuation of application No. PCT/KR2025/009144, filed on Jun. 27, 2025.

(30) Foreign Application Priority Data
Jun. 28, 2024 (IN) 202441049808
Jun. 13, 2025 (IN) 2024 41049808

(51) Int. Cl. G06T 1/60; G06T 11/00; G06T 13/80

(52) U.S. Cl. CPC G06T 1/60; G06T 11/00; G06T 13/80; G06T 2200/24

(57) ABSTRACT

An electronic device may create a maximum number of frames in a frame buffer queue for a foreground application based on a plurality of frame metrics, detect a scroll operation performed on the foreground application, determine a frame rendering duration of at least one frame based on an idle time on a main thread of the foreground application after detecting the scroll operation, generate an artificial synchronization pulse for creation of additional frames for the foreground application based on the frame rendering duration of the at least one frame, adjust a timeline of a scroll animation created independently of a display synchronization pulse, and display the additional frames by filling the additional frames into the frame buffer queue until the frame buffer queue reaches a maximum capacity.

### CROSS-REFERENCE TO RELATED APPLICATION(S)

This application is a continuation application, claiming priority under § 365(c), of an International application No. PCT/KR2025/009144, filed on Jun. 27, 2025, which is based on and claims the benefit of a Indian Patent Application number 202441049808, filed on Jun. 28, 2024, and a Indian Patent Application number 202441049808, filed on Jun. 13, 2025, in the Indian Intellectual Property Office, the disclosure of which is incorporated by reference herein in its entirety.

### BACKGROUND

### 1. Field

One or more embodiments of the present disclosure relate to a buffer queue management, and more particularly, to optimizing frame buffer management by an electronic device.

### 2. Description of Related Art

Modern mobile devices, particularly those operating on an Android Operating System (OS), including high-end models, often experience visual discontinuities referred to as janks during user interaction. Janks manifest as momentary stutters in animations and scrolling sequences that are expected to be fluid, resulting in a suboptimal user experience despite the advanced hardware capabilities of these devices.

The Android rendering pipeline operates under specific constraints that contribute to these performance issues, most notably a strict three-buffer limitation for rendering processes. These buffers function in a coordinated manner, with one buffer being drawn, another displayed, and a third waiting in a queue. This finite buffer allocation may become a bottleneck in the rendering pipeline.

Further, an Android's animation curve system dynamically adjusts rendering requirements based on interaction velocity. During rapid gestures, such as flings or fast scrolls, the animation curve system demands increased frame generation, placing additional pressure on the rendering pipeline. Under high computational load scenarios, particularly during rapid interaction patterns, the animation curve system struggles to maintain the three-buffer allocation consistently. The number of available buffers may temporarily drop to zero, especially when frame rendering may not be completed within the ˜8 ms budget required for 120 Hz displays. When this happens, no new frames are generated, leading to visible janks as the UI fails to update smoothly.

Existing systems designed to address these rendering pipeline issues have notable limitations. Many such systems rely on analyzing current frame complexity to project future workload or statically pre-rendering user interface (UI) elements during app launch. Some solutions focus on improving responsiveness to touch input by disabling vertical synchronization (VSYNC) for touch events, but they do not effectively address the dynamic demands of high-velocity scrolling. Furthermore, these systems typically fail to utilize idle processing time of the GPU or CPU to pre-render future frames or anticipate rapid interaction patterns.

During intensive scroll operations, if the application fails to render any new frames, the rendered frame count may effectively drop to zero. Despite this, a display compositor (e.g., SurfaceFlinger) continues to consume one buffer per VSYNC pulse, quickly exhausting available buffers. This leads to a severe rendering stall and observable performance degradation in the user interface.

Thus, it is desired to address the above-mentioned disadvantages, issues, or other shortcomings, or at least provide a useful alternative.

### SUMMARY

### Technical Solution

One or more embodiments of the present disclosure provide a method and an apparatus for optimizing the frame buffer management.

One or more embodiments of the present disclosure provide a method and an apparatus for determining a maximum frame buffer queue size (MFBQS) for an application executing on a display device using a pre-trained reinforcement learning model. The pre-trained reinforcement learning model may be trained over a predetermined period based on the number and duration of frame drops observed during the training phase.

One or more embodiments of the present disclosure provide a method and an apparatus for triggering an artificial VSYNC pulse to initiate rendering of a second frame in the buffer queue. This occurs when the rendering duration of at least one frame is less than a predefined threshold and there remains idle time before the next actual VSYNC pulse. The buffer queue may be progressively filled until the MFBQS for the application is reached.

One or more embodiments of the present disclosure provide a method and an apparatus for tuning the rendering of subsequent frames using an animation timeline, where the animation timeline is advance by each VSYNC interval to maintain uniformity in the scroll animation.

According to an aspect of the present disclosure, a method for optimizing frame buffer management by an electronic device, may include: creating a maximum number of frames in a frame buffer queue for a foreground application based on a plurality of frame metrics; detecting a scroll operation performed on the foreground application; determining a frame rendering duration of at least one frame based on an idle time on a main thread of the foreground application after detecting the scroll operation; generating an artificial synchronization pulse for creation of additional frames for the foreground application based on the frame rendering duration of the at least one frame; adjusting a timeline of a scroll animation created independently of a display synchronization pulse; and displaying the additional frames by filling the additional frames into the frame buffer queue until the frame buffer queue reaches a maximum capacity.

The method may further include determining the idle time by: measuring a duration of drawing and rendering of a current frame after detecting the scroll operation performed on the foreground application; and measuring the idle time based on the measured duration of the drawing and rendering of the at least one frame.

The generating of the artificial synchronization pulse may include: determining a system state of the electronic device based on a plurality of parameters, including the idle time of the main thread; determining whether the system state is suitable for activating an infinite buffer rendering (IBR); determining whether a frame buffer queue size is less than a maximum frame buffer queue size (MFBQS); and generating the artificial synchronization pulse independent of a periodic hardware synchronization pulse based on the system state meeting a condition for activating the IBR, and the frame buffer queue being less than the MFBQS.

The plurality of parameters may include at least one information of: a power saving mode; a motion smoothness level; a multi-window mode, wherein enabling the multi-window mode allows multiple application windows to be open simultaneously; a memory consumption amount; a battery level; a temperature of the electronic device; or an application refresh rate.

The artificial synchronization pulse may be generated after the frame rendering duration in the main thread of the foreground application when the buffer queue has empty slots to accommodate the additional frames generated by the IBR, and during the IBR, each of the additional frames may be generated at an artificial synchronization interval, resulting in an increase in the frame buffer queue size.

The main thread is a user interface (UI) thread, and wherein the determining of the frame rendering duration of the at least one frame may include: determining a start time when drawing of at least one frame starts and an end time when the drawing of at least one frame ends in the UI thread; and determining the frame rendering duration of the at least one frame based on a difference between the end time and the start time.

The filling of the additional frames into the frame buffer queue may include: monitoring the main thread to determine when the main thread is idle; and scheduling a draw call on the main thread to fill the additional frames into the frame buffer queue based on the application main thread being idle and the frame buffer queue having empty slots.

The creating of the maximum number of frame buffers may include: determining the plurality of frame metrics during the scroll operation in a training phase, wherein the plurality of frame metrics may include at least one of frame drop data or memory consumption data, the memory consumption data indicating memory used by frame buffers of the electronic device; determining a maximum frame buffer queue size (MFBQS) by inputting the plurality of frame metrics into a reinforcement learning model, wherein the MFBQS indicates a maximum number of frames that is allowed to be stored in the frame buffer queue at a given time; increasing the MFBQS to reduce frame drops during the scroll operation; and applying the increased MFBQS to the foreground application after the training phase is completed to create the maximum number of frames in the frame buffer queue for the foreground application.

The method may include: updating Q-table values based on the plurality of frame metrics during the training phase; selecting a state corresponding to a frame buffer queue size with a maximum Q-value as an optimal MFBQS after the Q-values have converged during the training phase; determining an action space including adjustments to the MFBQS, wherein the adjustments may include incrementing, decrementing, or maintaining the same MFBQS; determining a reward function that provides numerical rewards based on a current state and an action performed by the reinforcement learning model, wherein the reward function penalizes occurrences of frame drops; and setting a maximum buffer queue size to the MFBQS during further scroll sessions.

The adjusting of the timeline of the scroll animation may include: maintaining the timeline of the scroll animation independent of the display synchronization pulse; progressing the timeline of the scroll animation of the at least one frames uniformly by a display synchronization interval for uniform scrolling; computing scroll distances based on uniformly spaced timestamps; and accounting for frame drops by incrementing the timeline of the scroll animation by an amount of time the frame buffer queue spent without a buffer.

According to an aspect of the present disclosure, an electronic device may include: a memory, a processor, and a frame buffer controller connected to the memory and the processor, or incorporated into the processor, wherein the frame buffer controller is configured to: create a maximum number of frames in a frame buffer queue for a foreground application based on a plurality of frame metrics; detect a scroll operation performed on the foreground application; determine a frame rendering duration of at least one frame after detecting the scroll operation; generate an artificial synchronization pulse for creation of additional frames for the foreground application based the frame rendering duration of the at least one frame; adjust a timeline of a scroll animation created independently of display synchronization pulse; and display the additional frames by filling the additional frames into the frame buffer queue until the frame buffer queue reaches a maximum capacity.

The frame buffer controller may be further configured to: determine an idle time of a main thread of the foreground application based on a duration of drawing and rendering of a current frame after detecting the scroll operation, and determine the frame rendering duration based on the idle time.

The frame buffer controller may be further configured to: determine a system state of the electronic device based on a plurality of parameters, including the idle time; determine whether the system state is suitable for activating an infinite buffer rendering (IBR); determine whether a frame buffer queue size is less than a maximum frame buffer queue size (MFBQS); and generate the artificial synchronization pulse independent of a periodic hardware synchronization pulse based on the system state meeting a condition for activating the IBR, and the frame buffer queue being less than the MFBQS.

The plurality of parameters may include at least one information of a power saving mode, a motion smoothness level, a multi-window mode, a memory consumption amount, a battery level, a temperature of the electronic device, or an application refresh rate.

The artificial synchronization pulse may be generated after the frame rendering duration when the buffer queue has empty slots to accommodate the additional frames generated by the IBR, and during the IBR, each of the additional frames may be generated at an artificial synchronization interval, resulting in an increase in a frame buffer queue size.

### BRIEF DESCRIPTION OF THE DRAWINGS

The above and/or other aspects will be more apparent by describing certain example embodiments, with reference to the accompanying drawings, in which:

FIG. 1 is a schematic representation that illustrates a scroll rendering flow in android-based devices according to related art;

FIG. 2 is a block diagram that illustrates the electronic device for optimizing frame buffer management according to embodiments as disclosed herein;

FIG. 3 is a flowchart that illustrates a method for optimizing frame buffer management by an electronic device according to embodiments as disclosed herein;

FIG. 4A and FIG. 4B are flowcharts of optimizing the frame buffer management and training phase according to embodiments as disclosed herein;

FIG. 5 is a flowchart that illustrates a method for determining the suitability of activating infinite buffer rendering according to embodiments as disclosed herein;

FIG. 6 is a flowchart that illustrates the method implemented by the electronic device for optimizing frame buffer management during scroll animations using the IBR according to embodiments as disclosed herein;

FIG. 7 is the flowchart that illustrates the training phase for the MFBQS according to embodiments as disclosed herein;

FIGS. 8A and 8B is a graphical representation that illustrates that illustrates the correlation between the MFBQS and the percentage of frame drops observed during the scroll operations, according to embodiments as disclosed herein.

FIG. 9 is a flowchart that illustrates the frame scheduler implemented in the electronic device to trigger the IBR based on real-time frame rendering duration and buffer queue size according to embodiments as disclosed herein.

FIG. 10 is a schematic representation that illustrates the working of the frame scheduler within the frame buffer controller, according to embodiments as disclosed herein.

FIG. 11A and FIG. 11B are flowcharts that illustrate the animation timeline management implemented for adjusting the timeline of scroll animation independently of a display synchronization pulse according to embodiments as disclosed herein.

FIG. 12A and FIG. 12B are schematic representations that illustrate the beast mode operation of the ATM for optimizing frame buffer management during scroll animations according to embodiments as disclosed herein.

FIG. 13 is a flowchart that illustrates the working of the frame renderer according to embodiments as disclosed herein.

FIG. 14 is a schematic representation of a comparison of the frame rendering behavior in a social media application between a baseline scenario according to embodiments as disclosed herein.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

Embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings facilitate understanding of various technical features. The embodiments are not limited by these drawings and extend to any alterations, equivalents, and substitutes. Terms like first, second, etc., are used for distinction and do not limit the elements.

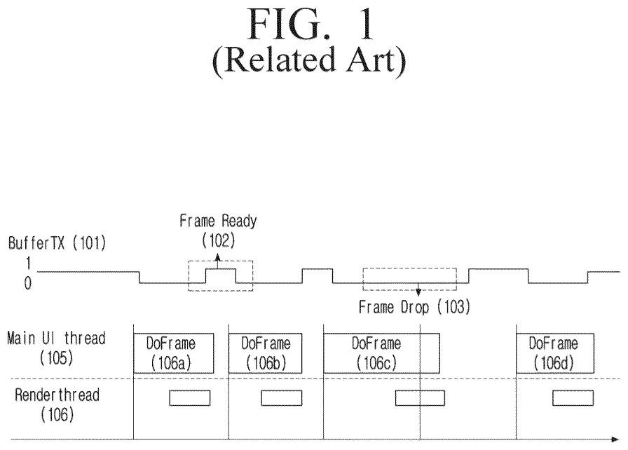

FIG. 1 is a schematic diagram illustrating the existing scroll rendering flow in mobile computing devices such as Android-based devices, highlighting the interaction between a main user interface (UI) thread 105, a RenderThread 106, SurfaceFlinger, and the VSYNC signal during the rendering and display of frames. The main UI thread 105, which is the main thread responsible for executing most of the application logic, initiates the rendering process by invoking the doFrame function 106a-106d. The doFrame function 106a-106d issues drawing commands for the frame to the RenderThread.

The RenderThread 106 processes the drawing commands received from the main UI thread 105) and communicates with a graphics user interface (GPU) to execute the rendering tasks. This process includes GPU-based rasterization of UI elements. Once the frame is rendered (see “Frame Ready 102”), it is passed to SurfaceFlinger, a system service responsible for compositing the rendered frame with other system elements such as the status bar or notifications. The composited frame is stored in a buffer queue referred to as BufferTX 101. The VSYNC 107 pulse or signal, generated at regular intervals (e.g., every 8.3 ms for a 120 Hz display), synchronizes the frame display with the display hardware. The time between the start of a doFrame 106a-106d call and the GPU completion is considered the frame completion time, which must be shorter than the VSYNC interval 1118 to avoid frame drops 103.

In scenarios involving complex or heavy frame computations (i.e., a “big” doFrame), SurfaceFlinger may consume all available buffers before the next frame is rendered. When the next VSYNC 107 pulse requests a frame but the buffer is not yet ready, a frame drop 103 occurs, resulting in visible jank during scrolling. Furthermore, Android devices support a maximum of three frame buffers in the queue by default. In a 120 Hz display scenario, the three buffers may sustain up to 24.9 milliseconds without the addition of a new buffer. If any operation on the main thread exceeds this 24.9 ms threshold, the buffer queue becomes empty, resulting in a frame drop 103.

To address these limitations, embodiments of the present disclosure introduces an advanced technique known as Infinite Buffer Rendering (IBR), aimed at enhancing scroll performance and delivering a smoother and more responsive user experience. The proposed IBR technique may overcome the limitation by dynamically increasing the Maximum Frame Buffer Queue Size (MFBQS) for each application. A Q-learning-based reinforcement learning agent is used to determine the optimal MFBQS value based on historical data, including the duration and frequency of frame drops observed during application usage.

Further, the IBR introduces an Animation Timeline Manager (ATM) 1111 that ensures the smooth progression of scroll and fling animations. The ATM 1111 adjusts the animation timeline uniformly, even in the presence of frame drops, by rendering frames at consistent visual distances. This intelligent timeline adjustment ensures that animations maintain visual continuity, thereby significantly improving the perceptual fluidity of high-velocity interactions.

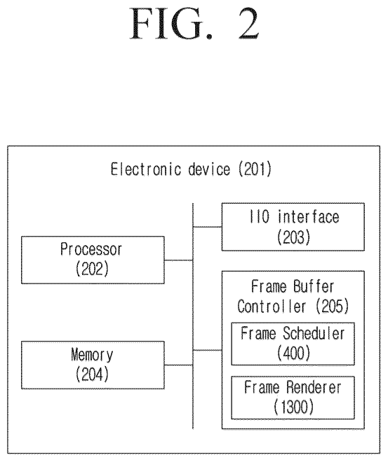

FIG. 2 is the block diagram that illustrates the electronic device for optimizing frame buffer management according to embodiments as disclosed herein. The electronic device 201 includes the processor 202, the memory 203, an input/output (I/O) interface 204, and the frame buffer controller 205. The processor 202 of the electronic device 201 communicates with the memory 203, the I/O interface 204, and the frame buffer controller 205. The processor 202 is configured to execute instructions stored in the memory 203 and to perform various processes. The processor 202 may include one or a plurality of processors, may be a general-purpose processor such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

Further, the memory 203 of the electronic device 201 includes storage locations to be addressable through the processor 202. The memory 203 is not limited to a volatile memory and/or a non-volatile memory. Further, the memory 203 may include one or more computer-readable storage media. The memory 203 may include non-volatile storage elements. For example, non-volatile storage elements may include magnetic hard disks, optical disks, floppy disks, flash memories, or forms of electrically programmable memories (EPROM) or electrically erasable and programmable (EEPROM) memories.

The I/O interface 204 transmits the information between the memory 203 and external peripheral devices. The peripheral devices are the input-output devices associated with the electronic device 201. The I/O interface 204 receives several pieces of information from the electronic device 201.

The frame buffer controller 205 is coupled to the memory 203 and the processor 202. This coupling allows for data transfer and communication between the components, ensuring that the frame buffer controller 205 may access and process frame data in real-time. The frame buffer controller 205 is an innovative integrated circuit that is implemented in the electronic device 201. In an embodiment, the structure of such an innovative integrated circuit includes a multi-core architecture that enables dynamic adjustment of frame buffer management in a display system. Each core is optimized for specific tasks such as signal processing, frame management, and adjusting frame buffer configurations, etc. The innovative integrated circuit for the dynamic adjustment of frame buffer management in the display system is made of a combination of analog and digital components designed to optimize the power consumption and performance of the scrolling mechanism. The analog components include a low-noise amplifier and a high-precision analog-to-digital converter to ensure signal processing. The digital components consist of a microcontroller unit (MCU) and a digital signal processor (DSP) that work in tandem to dynamically adjust the frame buffer management based on frame metrics.

The frame buffer controller 205 creates the maximum number of frames in the frame buffer queue for the foreground application based on the plurality of frame metrics. The foreground application may refer to a software application that is currently executing in the active user interface layer of an operating system. The user may be allowed to directly interact with the foreground application. In some embodiments, only one application may be designated as the foreground application at any given time on the operating system, while the present embodiments of the present application are not limited thereto. The frame buffer controller 205 detects a scroll operation performed on the foreground application. The frame buffer controller 205 determines the frame rendering duration of at least one frame after detecting the scroll operation performed on the foreground application. The frame buffer controller 205 generates the artificial synchronization pulse for creation of additional frames for the foreground application based on the frame rendering duration of at least one frame. The artificial synchronization pulse may be a software-generated timing signal initiated by the frame buffer controller independently of the periodic hardware-based vertical synchronization (VSYNC) pulses. The frame buffer controller 205 adjusts the timeline of the scroll animation created independently of display synchronization pulse to maintain uniformity in the scroll animation. The frame buffer controller 205 displays the additional frames by filling the additional frames into the frame buffer queue until the frame buffer queue reaches the maximum capacity. The frame buffer controller 205 utilizes a predictive algorithm to estimate the required number of frames based on user interaction patterns, ensuring smooth transitions during rapid scroll operations. Further, the controller dynamically allocates memory resources to accommodate the increased frame buffer demand, optimizing performance without compromising system stability.

The frame buffer controller 205 determines the idle time of the main thread of the foreground application for creation of additional frames, after detecting the scroll operation. The main thread (e.g., a main UI thread) in a foreground application may be a primary thread responsible for handling user interface operations, and may include drawings and rendering UI components, handling user input such as touch and scroll, running lifecycle methods, and dispatching events (e.g., animations, gestures, and updates to the UI). In some embodiment, only the main thread is allowed to update the UI directly, and any rendering tasks not offloaded to other threads (e.g., GPU or background workers) may be processed in the main thread, while the present embodiments are not limited thereto. The frame buffer controller 205 measures the duration of drawing and rendering of the current frame after detecting the scroll operation performed on the foreground application. The frame buffer controller 205 measures the idle time of the application main thread based on the measured duration of the drawing and rendering of the frame. For example, upon detecting a scroll operation, the frame buffer controller 205 may measure the duration during which the main thread is engaged in drawing and rendering a current frame (i.e., the busy time), and then may subtract this busy time from a total frame cycle duration to obtain the idle time available within the frame interval. The frame buffer controller 205 uses high-resolution timers to capture the rendering duration, ensuring precise synchronization of frame generation. Furthermore, the controller leverages multi-threading techniques to parallelize frame rendering tasks, reducing latency and enhancing the responsiveness of the foreground application during intensive scroll operations.

The frame buffer controller 205 generates the artificial synchronization pulse for creation of the additional frames. The frame buffer controller 205 determines the system state of the electronic device 201 based on the plurality of parameters including the idle time of an application main thread of the foreground application. The frame buffer controller 205 determines whether the system state is suitable for activating the IBR. The frame buffer controller 205 determines whether the frame buffer queue size is less than the MFBQS. The frame buffer controller 205 generates the artificial synchronization pulse independent of the periodic hardware synchronization pulses when the system state is suitable for activation of the IBR and the frame buffer queue is less than the MFBQS. The frame buffer controller 205 integrates adaptive algorithms to dynamically adjust the synchronization pulse frequency based on real-time system performance metrics, optimizing frame generation efficiency. Further, the controller incorporates power management protocols to minimize energy consumption during high frame rate operations, ensuring prolonged battery life without sacrificing visual quality.

The frame buffer controller 205 monitors the plurality of parameters to optimize frame buffer management. These parameters include power saving mode which is either on or off, motion smoothness which is either low or high, multiwindow mode which indicates whether multiple application windows are open simultaneously, the memory 203 consumption which is compared to the pre-defined threshold to determine whether the memory 203 consumption is more or less than the memory 203 consumption threshold, battery level which is compared to the pre-defined threshold to determine whether the battery level is more or less than the battery level threshold, device temperature which is compared to the pre-defined threshold to determine whether the device temperature is more or less than the device temperature threshold, and application refresh rate which is compared to the device display refresh rate to determine whether the application refresh rate is different or the same. The frame buffer controller 205 uses machine learning models to predict optimal parameter configurations, enhancing frame buffer management efficiency. Furthermore, the controller utilizes real-time analytics to continuously monitor and adjust system parameters, ensuring optimal performance under varying operational conditions.

The frame buffer controller 205 generates the artificial synchronization pulse after the frame rendering duration in the main thread of the foreground application when the buffer queue has empty slots to accommodate the additional frames generated by the IBR. In the IBR case, the additional frame is generated per artificial synchronization interval, resulting in the frame buffer queue size increment. The frame buffer controller 205 uses predictive algorithms to estimate the required number of frames based on user interaction patterns, ensuring smooth transitions during rapid scroll operations. Further, the controller dynamically allocates memory resources to accommodate the increased frame buffer demand, optimizing performance without compromising system stability.

The frame buffer controller 205 determines the frame rendering duration for at least one frame. The frame buffer controller 205 determines the start time when at least one frame drawing starts in the User Interface (UI) thread of the foreground application and the end time when at least one frame drawing ends in the UI thread. The frame buffer controller 205 determines the frame rendering duration for at least one frame as the difference between the end time and the start time. The frame buffer controller 205 utilizes high-resolution timers to capture the rendering duration, ensuring precise synchronization of frame generation. Furthermore, the controller leverages multi-threading techniques to parallelize frame rendering tasks, reducing latency and enhancing the responsiveness of the foreground application during intensive scroll operations.

The frame buffer controller 205 fills the additional frames into the frame buffer queue. The frame buffer controller 205 monitors the application main thread of the foreground application to determine when the application main thread is idle. The frame buffer controller 205 schedules the draw call on the application main thread to fill additional frames into the frame buffer queue whenever the application main thread is idle and the frame buffer queue has empty slots. The frame buffer controller 205 uses a priority-based scheduling algorithm to ensure timely execution of draw calls, optimizing frame buffer utilization. Further, the controller integrates real-time monitoring tools to track the status of the application main thread, enabling proactive management of frame buffer resources.

The frame buffer controller 205 creates the maximum number of frame buffers that may be pushed into the frame buffer queue for the foreground application based on the plurality of frame metrics. Further, the frame buffer controller 205 determines the plurality of frame metrics during the scroll operation in the training phase. The plurality of frame metrics includes at least one of frame drop 103 data and memory 203 consumption data including memory 203 used by frame buffers in the RAM of the electronic device 201. Further, the frame buffer controller 205 determines the MFBQS by inputting the plurality of frame metrics into the reinforcement learning model. The MFBQS indicates the maximum number of frames that may be stored in the frame buffer queue at any given time. Further, the frame buffer controller 205 increases the MFBQS value to reduce frame drops 103 while scrolling. Further, the frame buffer controller 205 applies the increased MFBQS value to the foreground application after the training phase is completed to create the maximum number of frames in the frame buffer queue for the foreground application. Further, the frame buffer controller 205 monitors the application main thread of the foreground application to determine when the application main thread is idle. Further, the frame buffer controller 205 schedules the draw call on the application main thread to fill additional frames into the frame buffer queue whenever the application main thread is idle and the frame buffer queue has empty slots. The frame buffer controller 205 uses advanced machine learning techniques to continuously refine the reinforcement learning model, ensuring optimal frame buffer management. Further, the controller integrates real-time analytics to dynamically adjust the MFBQS value based on current system performance, enhancing the user experience during intensive scroll operations.

The frame buffer controller 205 updates the Q-table values based on the plurality of frame metrics during the training phase. In reinforcement learning, a Q-table may be a lookup table that stores Q-values (e.g., Q(s,a)), which may represent an expected cumulative reward of taking a particular action “a” in a particular state “s”. The Q-table may have rows including possible states and columns including possible actions. The Q-value in each cell of the Q-table may be an estimated reward for choosing that action in that state, considering future rewards. Further, the frame buffer controller 205 selects the state corresponding to the frame buffer queue size with the maximum Q-value as the optimal MFBQS after the Q-values have converged during the training phase. The optimal MFBQS minimizes the frame drop 103 percentage without excessive memory 203 consumption. Further, the frame buffer controller 205 determines the action space comprising adjustments to the MFBQS value. The adjustments include incrementing, decrementing, or maintaining the same MFBQS value. Further, the frame buffer controller 205 determines the reward function that provides numerical rewards based on the current state and the action performed by the reinforcement learning model. The reward function penalizes when frame drops 103 occur. Further, the frame buffer controller 205 sets the maximum buffer queue size to the MFBQS value during further scroll sessions to achieve reduced frame drops 103. The frame buffer controller 205 uses a dynamic reward adjustment mechanism to fine-tune the reinforcement learning model, ensuring optimal performance under varying operational conditions. Further, the controller integrates real-time monitoring tools to continuously track system metrics, enabling proactive adjustments to the MFBQS value for enhanced frame buffer management.

Further, the frame buffer controller 205 adjusts the timeline of the scroll animation created independently of the display synchronization pulse to maintain uniformity in the scroll animation. Further, the frame buffer controller 205 maintains the timeline of the scroll animation independent of the display synchronization pulse. Further, the frame buffer controller 205 progresses the timeline of the scroll animation of the additional frames uniformly by the display synchronization interval for uniform scrolling. The frame buffer controller 205 computes the scroll distances based on uniformly spaced timestamps. The scroll distances are computed to provide a uniform visual experience. The frame buffer controller 205 accounts for frame drops 103 by incrementing the timeline of the scroll animation by the amount of time the frame buffer queue spent without the buffer. The frame buffer controller 205 uses advanced interpolation techniques to ensure smooth transitions between frames, enhancing the visual experience during scroll operations. Further, the controller integrates real-time analytics to dynamically adjust the scroll animation timeline based on current system performance, ensuring uniform scrolling under varying operational conditions.

The frame buffer controller 205 may include a frame scheduler 400 configured to manage the timing and sequencing of frame generation and queuing operations for a foreground application. The frame scheduler 400 determines whether conditions are appropriate to trigger the generation of additional frames based on real-time performance metrics. Specifically, the frame scheduler 400 may evaluate whether the duration of the current frame is less than a predefined frame duration threshold (FDT) and whether the frame buffer queue size is less than the maximum frame buffer queue size (MFBQS). If both conditions are satisfied, the scheduler initiates subsequent processing steps (e.g., artificial synchronization pulse generation or frame pre-rendering).

The frame buffer controller 205 may include a frame renderer 1300 configured to generate a visual content that is ultimately displayed on a display screen of the electronic device 201. The frame renderer 1300 may coordinate the measurement, layout, and rendering of UI elements based on application-specific and system-level constraints.

Although FIG. 2 illustrates the frame buffer controller 205 as being positioned separately from the processor 202, it should be understood that the frame buffer controller 205 may be implemented in various configurations. In some embodiments, the frame buffer controller 205 may be integrated within the processor 202 or implemented as a separate hardware component. For example, the frame buffer controller 205 may be realized as a software module or hardware logic embedded within a system-on-chip (SoC), and may reside within a graphics processing unit (GPU), an application processor, or a display engine. In other embodiments, the frame buffer controller 205 may be part of a dedicated display controller or graphics subsystem.

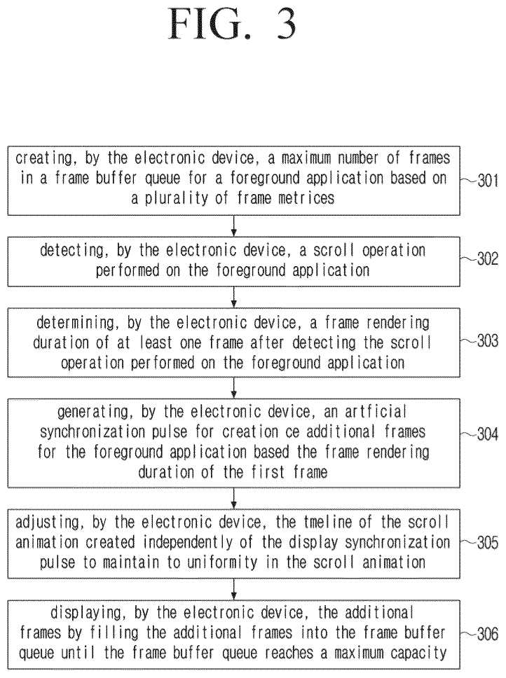

FIG. 3 is the flowchart that illustrates a method for optimizing frame buffer management by the electronic device 201 according to embodiments as disclosed herein.

At step 301, the method includes creating the maximum number of frames in the frame buffer queue for the foreground application through the electronic device 201 based on the plurality of frame metrics. These frame metrics may include parameters such as frame rate, rendering time, and system load. The electronic device 201 utilizes these metrics to determine the optimal number of frames that may be pre-rendered and stored in the buffer, ensuring that the application runs smoothly without unnecessary delays.

At step 302, the method includes detecting the scroll operation being performed on the foreground application through the electronic device 201 and monitoring the system parameter by the electronic device 201. The system parameters monitored may include CPU usage, memory availability, and GPU load. By continuously tracking these parameters, the electronic device 201 may dynamically adjust the frame buffer management strategy to adapt to changing system conditions and maintain optimal performance.

At step 303, the method includes determining the frame rendering duration of at least one frame after detecting the scroll operation performed on the foreground application through the electronic device 201. This includes measuring the time taken to render each frame during the scroll operation.

At step 304, the method includes generating the artificial synchronization pulse for creating additional frames for the foreground application through the electronic device 201 based on the frame rendering duration of the at least one frame. The artificial synchronization pulse is designed to align the frame generation process with the display's refresh cycle, minimizing visual artifacts such as tearing or stuttering. This pulse may be fine-tuned based on the rendering duration to ensure that new frames are generated just in time for display.

At step 305, the method includes adjusting the timeline of the scroll animation created independently of the display synchronization pulse through the electronic device 201 to maintain uniformity in the scroll animation. This adjustment includes recalibrating the animation timeline to match the actual frame rendering and display intervals. The electronic device 201 may use interpolation techniques to smooth out any discrepancies, ensuring that the scroll animation appears fluid and consistent to the user.

In an embodiment, the display synchronization pulse refers to a signal sent by the hardware of the electronic device 201. The display synchronization pulse may also be used to denote the timestamp at which the pulse or signal is received by the electronic device. Further, the display synchronization interval refers to the time interval between two consecutive display synchronization pulses. This interval maintains the timing of frame updates and ensuring that the display operates at its intended refresh rate.

At step 306, the method includes displaying the additional frames by filling them into the frame buffer queue through the electronic device 201 until the frame buffer queue reaches its maximum capacity.

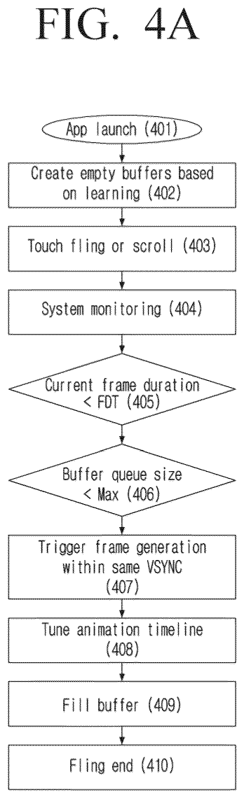

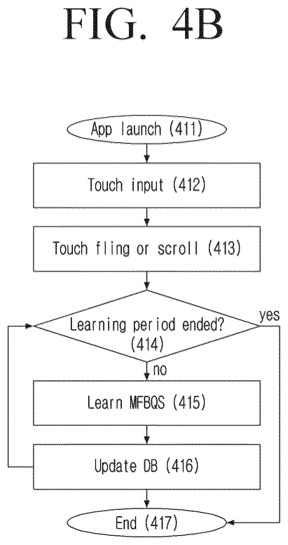

FIG. 4A illustrates the solution execution phase. At step 401 and 402, the application is launched on the electronic device 201 and the electronic device 201 creates empty frame buffers based on a learned MFBQS for the foreground application. The frame buffers are initialized to accommodate the rendering requirements of the application, ensuring that the system is prepared to handle dynamic content changes. The learned MFBQS is derived from historical data, optimizing the buffer size to balance memory usage and rendering performance.

At step 403 and 404, the frame buffer controller 205 in the electronic device 201 detects the scroll or fling gesture performed on the foreground application. Further, the electronic device 201 monitors current system parameters including the frame rendering duration and the buffer queue size. The detection mechanism utilizes touch input sensors and gesture recognition algorithms to identify user interactions. The system parameters are continuously updated to reflect real-time changes, allowing the frame buffer controller to make informed decisions about buffer management.

At step 406, the frame scheduler 400 in the frame buffer controller 205 checks if the current frame duration is less than the Frame Duration Threshold (FDT) and if the buffer queue size is less than the MFBQS. If both conditions are met, the control passes to step 407. The frame scheduler employs a timing analysis module to measure frame durations precisely, ensuring that the rendering process adheres to the predefined thresholds. The buffer queue size is monitored using a dynamic allocation algorithm that adjusts the buffer size based on current system load and application requirements.

At step 407, the frame buffer controller 205 in the electronic device 201 triggers frame generation within the same VSYNC interval 1118 by producing the artificial synchronization pulse. This artificial synchronization pulse is generated using a high-precision timer, which aligns the frame rendering process with the display refresh cycle, minimizing latency and improving visual smoothness. The synchronization mechanism ensures that frames are rendered consistently, reducing the likelihood of frame drops.

At step 408, the animation timeline is tuned to progress uniformly independent of the actual display VSYNC 107 pulses to confirm smooth scroll animation. The animation timeline is managed by an adaptive timing module that adjusts the progression rate based on user interactions and system performance metrics. This approach ensures that the animation remains fluid, even when the display refresh rate varies, providing a seamless user experience.

At steps 409 and 410, additional frames are filled into the frame buffer queue until it reaches the maximum queue size and fling end. The frame buffer controller employs a predictive filling algorithm that anticipates future frame requirements based on current user interactions, ensuring that the buffer queue is adequately populated. This method reduces the risk of buffer underflow, maintaining consistent animation quality throughout the fling gesture.

FIG. 4B illustrates the training phase of the infinite buffer rendering system. Specifically, it represents the manner in which the electronic device 201 learns the optimal MFBQS for the foreground application based on the observed frame drop 103 behavior and rendering performance during user interactions like scrolls or flings. The training phase includes collecting extensive performance data, which is analyzed using machine learning techniques to identify patterns and optimize buffer management strategies.

At steps 411, the application is launched during the training session or phase. The training session is initiated by a dedicated training module that configures the system to collect relevant performance metrics. This module ensures that the application operates under typical usage conditions, providing data for analysis.

At steps 412 and 413, the user interacts with the application through the touch input and performs the fling or scroll gesture on the application. The touch input is captured using high-resolution sensors, which provide detailed information about the user's interactions.

At step 414, the frame buffer controller 205 in the electronic device 201 collects frame metrics such as the frame drops 103 and rendering durations over a predefined training period. If yes, then the learning period ends and control passes to step 417. The collected metrics are stored in a performance database, which is used to train the reinforcement learning model. The predefined training period ensures that sufficient data is gathered to make predictions about optimal buffer sizes.

At step 415, the Q-learning-based reinforcement learning agent analyzes the collected data and learns the optimal MFBQS value for the application. The reinforcement learning agent employs a reward-based system to evaluate different buffer sizes, selecting the configuration that minimizes frame drops while maintaining memory usage. This process includes iterative adjustments and evaluations to converge on the optimal solution.

At step 416, the learned MFBQS is updated in the database and used in future scroll sessions to improve rendering performance and reduce frame drops 103. The updated MFBQS is stored in a persistent database, ensuring that the optimized buffer size is applied consistently across future sessions. This approach leverages historical data to improve the buffer size thereby enhancing scrolling performance and reducing frame drops

At step 417, the training phase ends and the learned MFBQS is applied in followed execution phases. The transition from the training phase to the execution phase is managed by a control module that ensures the system is configured correctly. This module verifies that the learned MFBQS is applied, optimizing buffer management for subsequent user interactions.

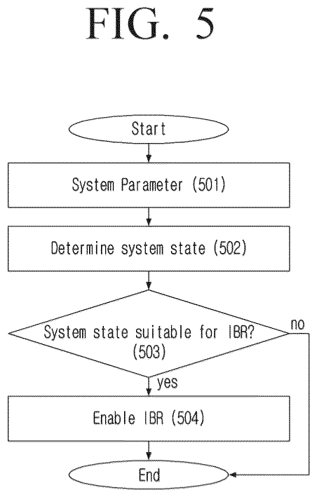

FIG. 5 is the flowchart that illustrates the method executed by the electronic device 201 to determine whether the system state is suitable for activating the IBR.

At step 501, the frame buffer controller 205 initiates the process by retrieving one or more system parameters including power saving mode (on/off), motion smoothness (low/high), multiwindow mode (enabled/disabled), memory 203 consumption (above or below a threshold), battery level (above or below a threshold), device temperature (above or below a threshold), and application refresh rate. These parameters are collected using a system monitoring module that provides real-time updates on the device's operational state. The module ensures that all relevant factors are considered when evaluating system readiness.

At step 502, the frame buffer controller 205 determines the current system state based on the retrieved parameters. Each parameter is individually compared with a corresponding predefined condition to assess the system readiness. The comparison process includes a series of conditional checks that evaluate whether the system meets the criteria for activating the IBR. This ensures that the system is operating within optimal conditions before proceeding.

At step 503, the frame buffer controller 205 checks whether the system state is suitable for activating the IBR. The system state is considered suitable when all the predefined conditions are satisfied. The suitability check is performed using a decision-making algorithm that aggregates the results of the individual parameter comparisons. If all conditions are met, the system is deemed ready for IBR activation.

At step 504, the frame buffer controller 205 activates the IBR when the system state is deemed suitable. The activation process includes configuring the frame buffer controller to use the infinite buffer rendering system, optimizing frame management for improved performance. This step ensures that the system is prepared to handle dynamic content changes, providing a smoother user experience.

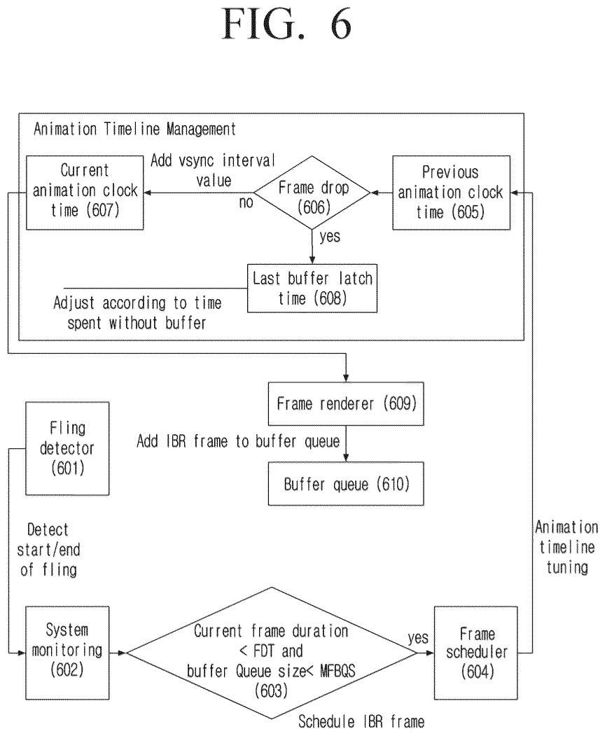

FIG. 6 is the flowchart that illustrates the method implemented by the electronic device 201 for optimizing frame buffer management during scroll animations using the IBR. The flowchart outlines the steps taken by the frame buffer controller to manage frame buffers and ensure smooth scroll animations.

At step 601, the frame buffer controller 205 initiates the process by detecting the scroll or fling gesture using a Fling Detector. The detection represents the start of a user-driven scroll event in the foreground application. The Fling Detector uses touch input sensors and gesture recognition algorithms to identify user interactions, providing detailed information about the start of the scroll event.

At step 602, the frame buffer controller 205 monitors the parameters through a system monitoring module. The system Monitoring module assesses operational conditions such as power mode, memory 203 usage, thermal state, and display refresh rate along with determining whether the application's main thread is idle. The monitoring module provides real-time updates on the device's operational state, ensuring that the frame buffer controller has information for decision-making.

At step 603, the frame buffer controller 205 evaluates the buffer and frame conditions by determining whether the current frame duration is less than the predefined Frame Duration Threshold (FDT) and whether the current buffer queue size is less than the MFBQS. These thresholds are predefined and optimized through machine learning techniques. The evaluation process includes a series of conditional checks that assess whether the system meets the criteria for optimal buffer management.

At step 604, the frame buffer controller 205 triggers artificial synchronization using the Frame Scheduler 400 when the conditions in step 603 are satisfied. The frame scheduler 400 generates the artificial synchronization pulse to prompt early frame rendering independent of the hardware-based VSYNC 107 pulse or signal. The artificial synchronization mechanism ensures that frames are rendered consistently, reducing the likelihood of frame drops and improving visual smoothness.

At step 605, the frame buffer controller 205 manages the animation timing through the animation the ATM which retrieves the previous animation clock time. The ATM uses an adaptive timing module to adjust the animation progression rate based on user interactions and system performance metrics. This approach ensures that the animation remains fluid, even when the display refresh rate varies, providing a seamless user experience.

At step 606, the frame buffer controller 205 determines the frame drop 103 condition. If no frame drop 103 is detected, control passes to step 607 to update the current animation clock time by adding the VSYNC interval 1118 value. If the frame drop 103 is detected, the control is passed to step 608 and the clock is adjusted using the Last Buffer Latch Time to account for rendering delays or absence of a valid buffer, thereby realigning the animation timeline. Further refines the animation clock based on the time spent without a buffer to minimize visual stutter. The frame drop detection mechanism uses a high-precision timer to measure frame rendering times, ensuring that the animation timeline is adjusted.

At step 609, the frame buffer controller 205 renders the frame using a frame renderer 1300. The frame renderer 1300 generates the UI frame in response to the artificial VSYNC 1205 and calculates the frame rendering time by recording the start and end timestamps. The rendering process includes generating the visual content for the application, ensuring that the frame is ready for display.

At step 610, the frame buffer controller 205 queues the rendered frame into the buffer Queue. If the buffer queue has available space (i.e., queue size is less than MFBQS), the rendered frame is inserted for eventual display, confirming smoother and more responsive scroll animations. The queuing process uses a dynamic allocation algorithm to manage buffer space, ensuring that the system may handle dynamic content changes without performance degradation.

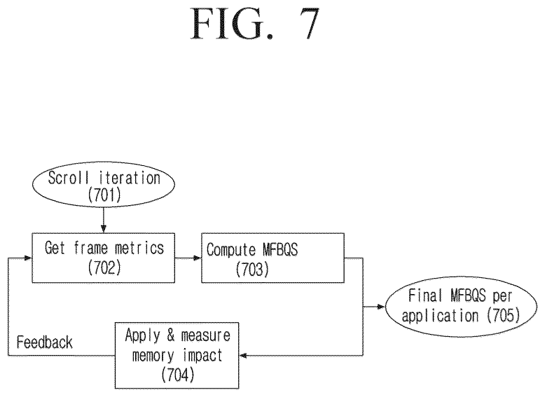

FIG. 7 is the flowchart that illustrates the training phase for the MFBQS. At step 701, the frame buffer controller 205 initiates the scroll iteration to initiate the training phase, serving as the entry point for the Buffer Queue Manager to start observing the scroll behavior. The training phase includes collecting extensive performance data, which is analyzed using machine learning techniques to identify patterns and optimize buffer management strategies.

At step 702, the frame buffer controller 205 collects frame metrics during the scroll operation, gathering data on the frame drops 103 during fling actions, measuring memory 203 consumption by frame buffers. The collected metrics are stored in a performance database, which is used to train the reinforcement learning model. The predefined training period ensures that sufficient data is gathered to make predictions about optimal buffer sizes.

At step 703, the frame buffer controller 205 computes the MFBQS by inputting the collected frame metrics into a reinforcement learning model, updating Q-table values, and determining the appropriate actions for buffer size adjustment. The reinforcement learning agent employs a reward-based system to evaluate different buffer sizes, selecting the configuration that minimizes frame drops while maintaining memory usage. This process includes iterative adjustments and evaluations to converge on the optimal solution.

At step 704, the frame buffer controller 205 applies the computed MFBQS value to the application and measures the resulting memory 203 impact, testing the scroll performance with new buffer queue size and analyzing the tradeoffs between smoothness and resource usage. The application of the computed MFBQS includes configuring the frame buffer controller to use the optimized buffer size, ensuring that the system is prepared to handle dynamic content changes.

At step 705, the frame buffer controller 205 stores the MFBQS per application, saving the optimized buffer queue size for followed scroll sessions and maintaining application-specific settings for future use. The updated MFBQS is stored in a persistent database, ensuring that the optimized buffer size is applied consistently across future sessions.

In the training phase, the frame buffer controller 205 establishes a feedback loop, returning performance data from step 704 to step 702, continuing refinement of frame metrics and converging on the optimal MFBQS that minimizes frame drops 103 without excessive memory 203 consumption. The feedback loop ensures that the system continuously improves its buffer management strategies, adapting to changing conditions and user interactions.

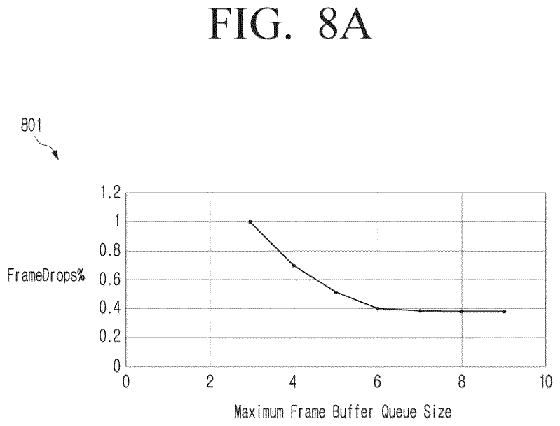

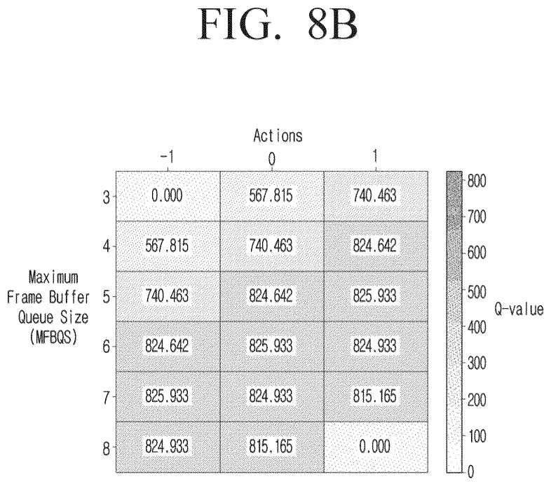

FIGS. 8A and 8B is the graphical representation 801 that illustrates the correlation between the MFBQS and the percentage of frame drops 103 observed during the scroll operations. The vertical axis (y-axis) represents the percentage of frame drops 103 while the horizontal axis (x-axis) corresponds to the varying values of the MFBQS. The curve represents a clear trend of decreasing frame drop 103 percentage as the buffer size increases, with a point of saturation where further increases in buffer size yield minimal performance gains. The graphical representation provides a visual summary of the relationship between buffer size and rendering performance, highlighting the importance of optimizing buffer management strategies.

The heatmap represents the Q-values generated during the reinforcement learning training phase of the buffer queue size optimization. The vertical axis represents discrete MFBQS values (states) while the horizontal axis represents available actions (e.g., increase, decrease, or maintain the buffer size). The heatmap provides a visual summary of the reinforcement learning process, highlighting the optimal actions for different buffer sizes. This representation helps to understand the decision-making process used by the reinforcement learning agent, providing insights into the system's behavior and performance.

In an embodiment, the reinforcement learning based approach is used for determining the optimal MFBQS per application. The reinforcement learning agent is trained using the Q-learning technique during initial scroll sessions until convergence of Q-values is achieved. Upon convergence, during following scroll sessions, the determined MFBQS value is applied resulting in improved performance characterized by reduced frame drops 103 without incurring additional memory 203 cost.

A state space (S) represents the current system state, in which each state s∈S is defined as a possible value of the MFBQS. In the proposed methodology, the state space is given as
S={s|s∈{s1,s2, . . . , sn}}, where the MFBQS ranges from 3 to 8

The action space (A) includes permissible actions for adjusting the MFBQS. Each action a∈A corresponds to one of the incrementing the MFBQS by 1, decrementing the MFBQS by 1, or maintaining the current value. Accordingly, the action space is A=[−1, 0, 1].

A reward function (R) provides a numerical reward based on the current state and the action executed by the RL agent. The reward function penalizes frame drops 103 heavily and applies a lighter penalty to the memory 203 usage. The intent is to increment the MFBQS only until a point where further increases do not significantly reduce frame drops 103. The reward function is given as,
R(st,at)=−ω·ft−ωm·bt+K, where ωf and ωm are the weights to reward or penalize frame drops 103 and frame buffer count. ft is the percentage of the frame drops 103 and bt is the current frame buffer count. K is a large positive constant to deal with variance of small values.

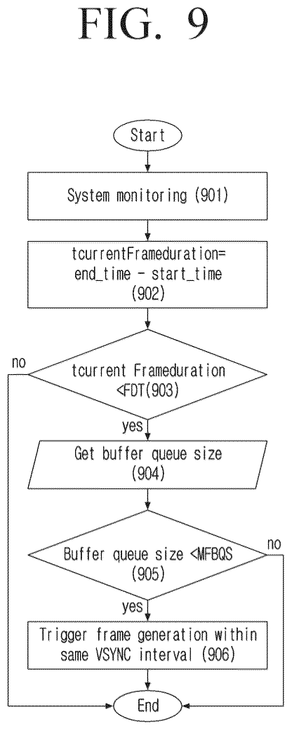

FIG. 9 is the flowchart that illustrates the frame scheduler implemented in the electronic device 201 to trigger IBR based on real-time frame rendering duration and buffer queue size.

At step 901, the frame buffer controller 205 initiates system monitoring during the frame rendering operations.

At step 902, the frame buffer controller 205 calculates the current frame duration (t_{currentFrameDuration}) based on the difference between the end time (indicating the time at which frame rendering ends) and the start time (indicating the time at which frame rendering begins) within a UI thread. The time for frame rendering is calculated as t_{currentFrameDuration}=end_time−start_time

At step 903, the frame buffer controller 205 determines whether t_{currentFrameDuration} exceeds the predefined Frame Duration Threshold (FDT). Let ‘s’ represent the decision whether IBR is to be invoked, s=1 if t_{currentFrameDuration} is less than the FDT and current frame buffer queue size is less than MFBQS. s=0 if t_{currentFrameDuration} is greater than or equal to the FDT or current frame buffer queue size is equal to MFBQS.
where FDT (Frame Duration Threshold) may be Vsync/N where N=1, 2, 3 . . . .

If t_{currentFrameDuration} is less than the FDT, the control passes to step 904 and if the buffer queue size is less than the MFBQS, the control passes to step 906.

At step 904, the frame buffer controller 205 determines a current buffer queue size

At step 905, the buffer queue size is compared with the predefined or dynamically learned threshold of the MFBQS. The MFBQS may be arranged based on system parameters or machine learning models that evaluate optimal frame processing performance. If the buffer queue size is found to be less than the MFBQS, the control passed to step 906.

At step 906, the frame buffer controller 205 triggers the generation of the next frame within the same VSYNC interval 1118, thereby enabling the IBR. This flow confirms optimal rendering performance by adapting the frame scheduling based on the real time system load.

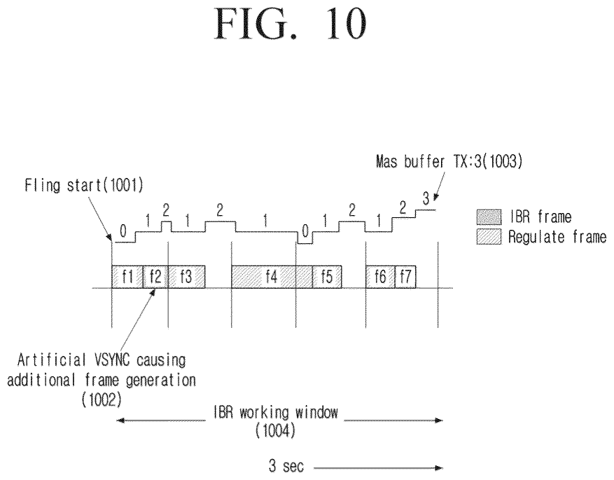

FIG. 10 is a schematic representation that illustrates the working of the frame scheduler within the frame buffer controller. An artificial VSYNC 1205 pulses are scheduled during idle times of the main thread to generate additional frames (IBR frames), provided the buffer queue has sufficient empty slots. The IBR frames (f2, f7) are generated within the defined IBR working window 1004 (3 seconds), and transmission is controlled to not exceed the maximum buffer threshold (Max Buffer TX: 3) 1003.

Below comparative table representing the frame generation behavior between the base frame rendering method and IBR, within the 3-second IBR working window.

| | | | Buffer | Buffer queue | |
|---|---|---|---|---|---|
| | Current frame | | queue size | size (IBR- | IBR frame |
| Frame ID | duration | | (base) | proposed) | injected |
| f1 | 3 | ms | 1 | 1 | — |
| f2 | — | | — | 2 | Yes |
| f3 | 5 | ms | 1 | 2 | — |
| f4 | 11 | ms | 1 | 1 | |
| f5 | 3 | ms | 2 | 2 | — |
| f6 | 3 | ms | 2 | 2 | — |
| f7 | 3 | ms | — | 3 | Yes |

In the first VSYNC interval 1118, the base method schedules only frame f1, resulting in the buffer queue size of 1. In contrast, the IBR method schedules an additional artificial frame f2, increasing the buffer queue size to 2.

Similarly, during the VSYNC interval 1118, the base method schedules only frame f6, leading to a queue size of 2, whereas IBR introduces an additional frame f7, reaching the maximum buffer queue size of 3.

These additional frames generated by IBR help populate the buffer queue proactively, minimizing the risk of the frame drops 103 during following rendering intervals by leveraging idle time in the main thread for artificial VSYNC-triggered frame generation.

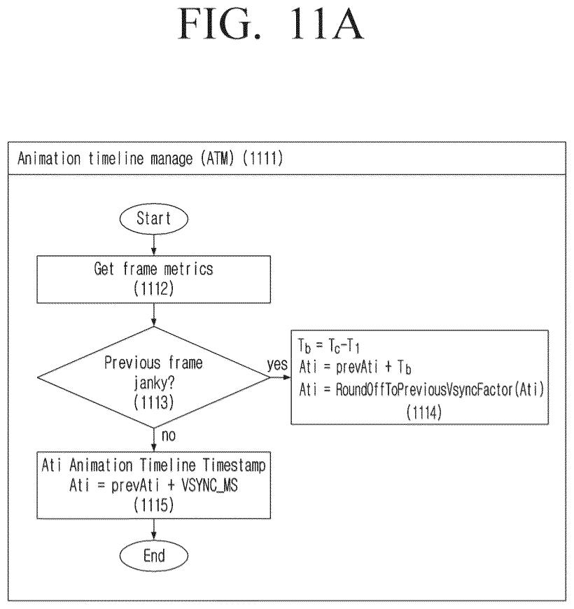

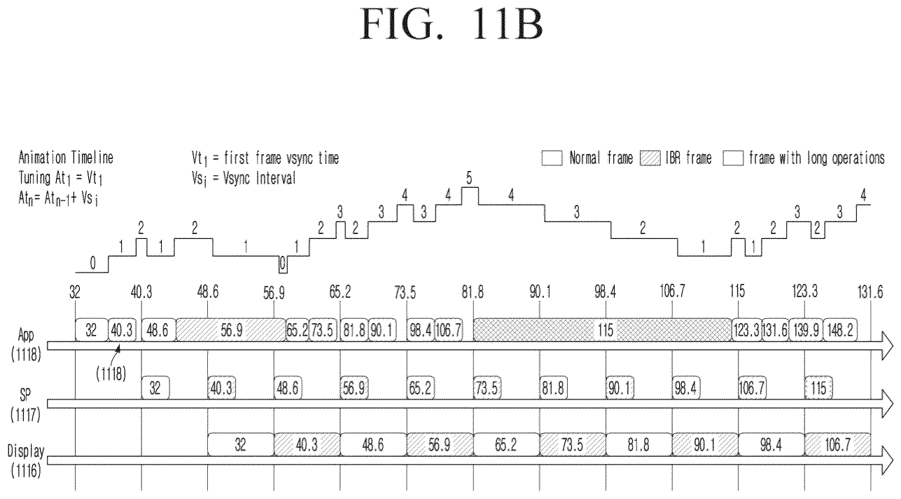

FIG. 11A is the flowchart that illustrates the ATM 1111 implemented for adjusting a timeline of scroll animation independently of a display synchronization pulse.

At step 1112 the process starts with the frame buffer controller 205 obtaining the frame metrics. These metrics include the frame rate, frame duration, and any discrepancies in frame rendering times. The frame buffer controller 205 uses these metrics to assess the performance of the animation and identify any potential issues that may affect the smoothness of the scroll animation.

At step 1113 the frame buffer controller 205 then checks whether the previous frame is janky. If the previous frame is janky, then the control passes to step 1114, and if the previous frame is not janky, the control passes to step 1115. A janky frame is one that does not meet the expected rendering time, causing a noticeable disruption in the animation. The frame buffer controller 205 uses a predefined threshold to determine if a frame is janky, ensuring that only significant deviations from the expected performance trigger adjustments to the animation timeline.

At step 1114 the frame buffer controller 205 resets the animation timeline timestamp (Ati by rounding the previous frame end time to the nearest last synchronization point. The time spent without frame buffering is calculated as T_{b}=T_{c}−Tₗ, where Tc is the current time and Tₗ is the timestamp when the last frame buffer was latched. The updated timeline is then calculated as Ati=prevAti+Tb, and realigned using Ati=RoundOffToPreviousVsyncFactor(Ati) to synchronize with the previous VSYNC pulse. By resetting the timeline, the frame buffer controller 205 helps maintain a consistent visual experience, even when individual frames are dropped or delayed.

At step 1115, the frame buffer controller 205 updates the animation timeline by adding a VSYNC interval 1118 (VSYNC_MS) to a previous animation time (prevAti). This confirms that the scroll animation timeline progresses uniformly and independently of the display sync pulses, which helps maintain consistent visual performance even when frames are dropped. The VSYNC interval is a predefined duration that represents the time between successive display synchronization pulses. By adding this interval to the provisional timeline, the frame buffer controller 205 ensures that the animation progresses at a steady pace, regardless of any disruptions in the display synchronization.

FIG. 11B is the schematic diagram that represents the ATM 1111 independently of the VSYNC 107 pulse-based timestamps. For example, in the first VSYNC interval 1118, the fling animation runs at timestamp 40.3 even though the VSYNC 107 timing has not yet occurred.

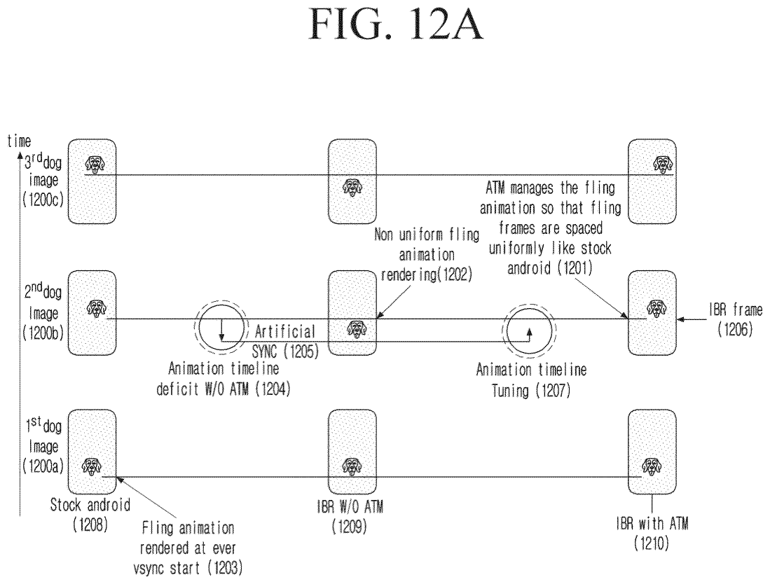

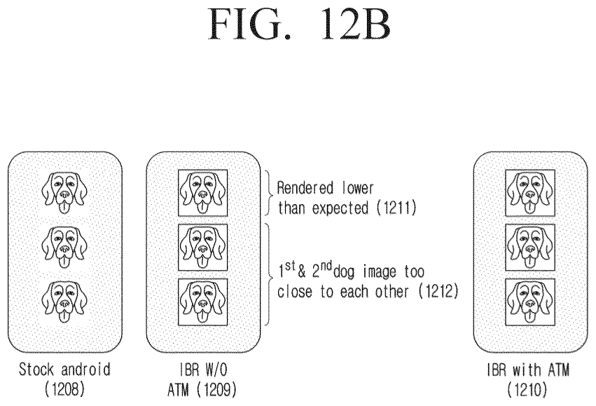

FIG. 12A discloses a comparison of a Stock Android 1208, an IBR without the ATM (Infinite Buffer Renderingwithout ATM) 1209, and an IBR with the ATM (Infinite Buffer Renderingwith the ATM) 1210. The Figure represents the progression of time vertically with three rows representing different dog images of a first dog image 1200a, a second dog image 1200b, and a third dog image 1200c. This comparison highlights the differences in animation performance between the three implementations, providing a visual representation of how the ATM improves scroll animations.

In the Stock Android 1208 implementation, the fling animation is rendered at every VSYNC start 1203. The timeline represents frame rendering at regular synchronization intervals for each of the dog images. This approach ensures that the animation is synchronized with the display refresh rate, providing a consistent visual experience. However, it may be prone to frame drops if the display synchronization pulse is irregular.

In the IBR Without ATM 1209 implementation, non-uniform fling animation rendering 1202 occurs. The timeline represents standard frame rendering and an additional frame created through the artificial VSYNC 1205 between the 1st and 2nd dog images. This artificial synchronization pulse allows for the creation of additional frames independent of the display synchronization pulse. However, this implementation suffers from animation timeline deficit without the ATM 1204, as indicated by the downward arrow in the circle, resulting in non-uniform animation. The lack of proper timeline management leads to inconsistencies in the animation, affecting the overall visual experience.

In the IBR with the ATM implementation 1210, the ATM 1111 manages the fling animation so that the fling frames are spaced uniformly like the stock Android 1201. The implementation includes Animation Timeline Tuning 1207, represented by the upward arrow in the circle, which confirms the uniform frame spacing despite the creation of additional IBR frames 1206. This approach maintains visual consistency by properly managing the animation timeline while benefiting from the additional frames created through the artificial synchronization pulses. The ATM ensures that the animation remains smooth and responsive, even when additional frames are introduced.

FIG. 12A discloses the manner in which the IBR with the ATM implementation combines the benefits of additional frame creation with proper animation timeline management to maintain uniformity in scroll animations, thereby reducing the frame drops 103 while ensuring smooth scrolling experiences.

FIG. 12B is a schematic representation that illustrates a comparison of the three implementations: the stock Android 1208, the IBR without the ATM 1209, and the IBR with the ATM 1210, with all three dog images superimposed together.

Superimposing all three dog images 1200a-1200c rendering together clearly represents the problem when the IBR without the ATM 1209 is used. In the IBR without the ATM 1209, some images are rendered lower than expected 1211, and the first and second dog images appear too close to each other 1212. This represents the non-uniform animation that occurs without proper timeline management. The lack of proper timeline management leads to inconsistencies in the animation, affecting the overall visual experience.

Further, in contrast, both the stock Android 1208 and the IBR With ATM 1210 implementations represent uniform spacing between the dog images, with the IBR with the ATM 1210 maintaining proper animation consistency while benefiting from additional frames. FIG. 12B represents the visual inconsistencies that occur when implementing the IBR without a proper ATM and how the addition of the ATM 1111 resolves these issues while maintaining the performance benefits of IBR. The ATM ensures that the animation remains smooth and responsive, even when additional frames are introduced.

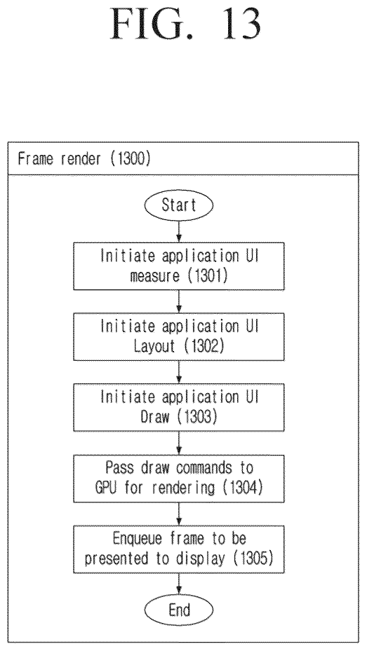

FIG. 13 is the flowchart that illustrates the working of the frame renderer 1300. The frame renderer generates the visual content that is displayed on the screen.

At step 1301 the frame renderer 1300 in the frame buffer controller 205 requests the application UI to measure itself to determine the appropriate size of each UI widget. This step includes calculating the dimensions of each UI element based on the layout specifications and the available screen space.

At step 1302 a spatial positioning of the measured UI widgets is computed to prepare for drawing. This includes determining the exact coordinates where each UI element will be placed on the screen. The spatial positioning ensures that the UI elements are arranged in a visually appealing and functional manner, providing a seamless user experience.

At step 1303 the UI widgets are rendered by generating draw commands. These commands are passed to the GPU. The draw commands specify the graphical operations needed to render each UI element, including the shapes, colors, and textures. The GPU processes these commands to generate the final visual content.

At step 1304 the draw commands are executed on the GPU, which processes and converts them into the frame buffer containing pixel data. The GPU performs the necessary calculations to transform the draw commands into pixel data, which is then stored in the frame buffer. This pixel data represents the final rendered image that will be displayed on the screen.

At step 1305 the rendered frame is enqueued for presentation on the display through the electronic device's 201 window composition system. The window composition system manages the display of the rendered frames, ensuring that they are presented in the correct order and at the appropriate times.

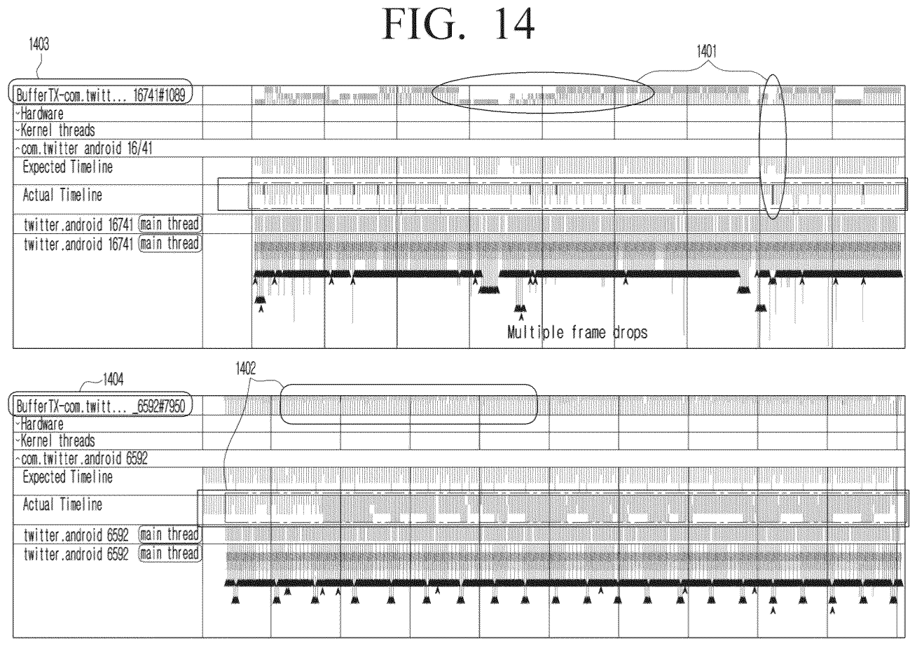

FIG. 14 is the schematic representation of the comparison of the frame rendering behavior in a social media application between a baseline scenario and the IBR enabled scenario using the Perfetto trace analysis. Perfetto is a performance analysis tool that provides detailed insights into the rendering behavior of applications, helping identify areas for optimization.

In the base case, the BufferQueue exhibits instability with the BufferTX 101 sizes fluctuating between 0 to 3, causing frequent frame drops 103 as evidenced by the discontinuities in the rendered frames and gaps in the buffer queue. This instability leads to a poor user experience, with noticeable disruptions in the animation and scrolling performance.

Conversely, in the IBR scenario, the buffer queue size is consistently maintained at six throughout the operation. This stable buffer management ensures that all frames are rendered without drops, as observed in the continuous green timeline in the Perfetto trace. The comparison highlights that IBR effectively regulates the buffer queue, mitigating frame drops 103 and enhancing overall rendering stability in high-scroll applications. The consistent buffer management provided by IBR ensures a smooth and responsive user experience, even in demanding scenarios.

The present embodiments may improve scroll performance in the electronic devices 201 by optimizing frame buffer management. The RL approach is used to increase the maximum number of buffers in the frame buffer queue based on the frame drop 103 data, such as the number and duration of the frame drops 103. This approach leverages machine learning techniques to dynamically adjust the buffer queue size, ensuring optimal performance based on real-time data.

Further, the embodiments may monitor the main thread of the foreground application for idle time and triggers frame generation independent of the VSYNC pulse. This confirms that additional frames are added to the buffer queue, increasing the number of available buffers. By generating frames during idle times, the embodiments may ensure that the buffer queue remains full, reducing the likelihood of frame drops and improving overall performance.

The rendering process continues until the buffer queue is full in the SurfaceFlinger, and the scroll animation duration is adjusted to maintain smooth scrolling as the additional frames are generated independently of the VSYNC pulse.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology used herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for optimizing frame buffer management by an electronic device, comprising:
creating a maximum number of frames in a frame buffer queue for a foreground application based on a plurality of frame metrics;
detecting a scroll operation performed on the foreground application;
determining a frame rendering duration of at least one frame based on an idle time on a main thread of the foreground application after detecting the scroll operation;
generating an artificial synchronization pulse for creation of additional frames for the foreground application based on the frame rendering duration of the at least one frame;
adjusting a timeline of a scroll animation created independently of a display synchronization pulse; and
displaying the additional frames by filling the additional frames into the frame buffer queue until the frame buffer queue reaches a maximum capacity.

2. The method as claimed in claim 1, further comprising determining the idle time by:
measuring a duration of drawing and rendering of a current frame after detecting the scroll operation performed on the foreground application; and
measuring the idle time based on the measured duration of the drawing and rendering of the at least one frame.

3. The method as claimed in claim 1, wherein the generating of the artificial synchronization pulse comprises:
determining a system state of the electronic device based on a plurality of parameters, comprising the idle time of the main thread;
determining whether the system state is suitable for activating an infinite buffer rendering (IBR);
determining whether a frame buffer queue size is less than a maximum frame buffer queue size (MFBQS); and
generating the artificial synchronization pulse independent of a periodic hardware synchronization pulse based on the system state meeting a condition for activating the IBR, and the frame buffer queue being less than the MFBQS.

4. The method as claimed in claim 3, wherein the plurality of parameters comprises at least one information of:
a power saving mode;
a motion smoothness level;
a multi-window mode, wherein enabling the multi-window mode allows multiple application windows to be open simultaneously;
a memory consumption amount;
a battery level;
a temperature of the electronic device; or
an application refresh rate.

5. The method as claimed in claim 3, wherein the artificial synchronization pulse is generated after the frame rendering duration in the main thread of the foreground application when the buffer queue has empty slots to accommodate the additional frames generated by the IBR, and
during the IBR, each of the additional frames is generated at an artificial synchronization interval, resulting in an increase in the frame buffer queue size.

6. The method as claimed in claim 1, wherein the main thread is a user interface (UI) thread, and wherein the determining of the frame rendering duration of the at least one frame comprises:
determining a start time when drawing of at least one frame starts and an end time when the drawing of at least one frame ends in the UI thread; and
determining the frame rendering duration of the at least one frame based on a difference between the end time and the start time.

7. The method as claimed in claim 1, wherein the filling of the additional frames into the frame buffer queue comprises:
monitoring the main thread to determine when the main thread is idle; and
scheduling a draw call on the main thread to fill the additional frames into the frame buffer queue based on the application main thread being idle and the frame buffer queue having empty slots.

8. The method as claimed in claim 1, wherein the creating of the maximum number of frame buffers comprises:
determining the plurality of frame metrics during the scroll operation in a training phase, wherein the plurality of frame metrics comprises at least one of frame drop data or memory consumption data, the memory consumption data indicating memory used by frame buffers of the electronic device;
determining a maximum frame buffer queue size (MFBQS) by inputting the plurality of frame metrics into a reinforcement learning model, wherein the MFBQS indicates a maximum number of frames that is allowed to be stored in the frame buffer queue at a given time;
increasing the MFBQS to reduce frame drops during the scroll operation; and
applying the increased MFBQS to the foreground application after the training phase is completed to create the maximum number of frames in the frame buffer queue for the foreground application.

9. The method as claimed in claim 8, the method comprising:
updating Q-table values based on the plurality of frame metrics during the training phase;
selecting a state corresponding to a frame buffer queue size with a maximum Q-value as an optimal MFBQS after the Q-values have converged during the training phase;
determining an action space comprising adjustments to the MFBQS, wherein the adjustments comprise incrementing, decrementing, or maintaining the same MFBQS;
determining a reward function that provides numerical rewards based on a current state and an action performed by the reinforcement learning model, wherein the reward function penalizes occurrences of frame drops; and
setting a maximum buffer queue size to the MFBQS during further scroll sessions.

10. The method as claimed in claim 1, wherein the adjusting of the timeline of the scroll animation comprises:
maintaining the timeline of the scroll animation independent of the display synchronization pulse;
progressing the timeline of the scroll animation of the at least one frames uniformly by a display synchronization interval for uniform scrolling;
computing scroll distances based on uniformly spaced timestamps; and
accounting for frame drops by incrementing the timeline of the scroll animation by an amount of time the frame buffer queue spent without a buffer.

11. An electronic device comprising:
a memory,
a processor, and
a frame buffer controller connected to the memory and the processor, or incorporated into the processor, wherein the frame buffer controller is configured to:
create a maximum number of frames in a frame buffer queue for a foreground application based on a plurality of frame metrics;
detect a scroll operation performed on the foreground application;
determine a frame rendering duration of at least one frame after detecting the scroll operation;
generate an artificial synchronization pulse for creation of additional frames for the foreground application based the frame rendering duration of the at least one frame;
adjust a timeline of a scroll animation created independently of display synchronization pulse; and
display the additional frames by filling the additional frames into the frame buffer queue until the frame buffer queue reaches a maximum capacity.

12. The electronic device of claim 11, wherein the frame buffer controller is further configured to:
determine an idle time of a main thread of the foreground application based on a duration of drawing and rendering of a current frame after detecting the scroll operation, and
determine the frame rendering duration based on the idle time.

13. The electronic device of claim 11, wherein the frame buffer controller is further configured to:
determine a system state of the electronic device based on a plurality of parameters, comprising the idle time;
determine whether the system state is suitable for activating an infinite buffer rendering (IBR);
determine whether a frame buffer queue size is less than a maximum frame buffer queue size (MFBQS); and
generate the artificial synchronization pulse independent of a periodic hardware synchronization pulse based on the system state meeting a condition for activating the IBR, and the frame buffer queue being less than the MFBQS.

14. The electronic device of claim 13, wherein the plurality of parameters comprises at least one information of a power saving mode, a motion smoothness level, a multi-window mode, a memory consumption amount, a battery level, a temperature of the electronic device, or an application refresh rate.

15. The electronic device of claim 11, wherein the artificial synchronization pulse is generated after the frame rendering duration when the buffer queue has empty slots to accommodate the additional frames generated by the IBR, and
during the IBR, each of the additional frames is generated at an artificial synchronization interval, resulting in an increase in a frame buffer queue size.
